(19) United States
(12) Patent Application Publication
(10) Pub. No.: US 2014/0323927 A1
(43) Pub. Date: Oct. 30, 2014

(54) Device for Skin Care and Massaging

(71) Applicant: Nancy Y. KIM, Los Angeles, CA (US)

(72) Inventor: Nancy Y. KIM, Los Angeles, CA (US)

(21) Appl. No.: 13/870,219

(22) Filed: Apr. 25, 2013

(51) Int. Cl. A61H 15/02; A61H 15/00

(52) U.S. Cl. CPC A61H 15/02; A61H 15/0092; A61H 2015/0014
USPC 601/19; 601/15

(57) ABSTRACT

A device for skin care and massaging includes a main body, a galvanic current applier, a massager, a massaging pointing portion, and a massaging serially-protruding portion. The galvanic current applier is provided in the main body and configured for applying galvanic current from a first portion of skin of a user to a second portion of skin of the user, the galvanic current applier comprising a conductive surface disposed on the bottom portion of the main body. The massager is provided next to the galvanic current applier in the main body and configured for contacting and applying mechanical vibration onto a third portion of skin of the user, the massager comprising a substantially flat surface disposed on the bottom portion of the main body.

The present invention relates to a device for skin care and massaging. More particularly, this invention relates to a device, in which the functions for skin care and massaging are provided in one body.

### BACKGROUND OF THE INVENTION

Skin care and massaging seem to be related very closely, but they have been provided separately conventionally.

Sine the devices for each of the services are distinctly different, it has been natural to provide each of the devices separately.

However, they are related closely enough, usually the two services must be provided together in the same place.

Accordingly, a need for such a deice has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a device for skin care and massaging.

An aspect of the invention provides a device for skin care and massaging.

The device comprises a main body, a galvanic current applier, a massager, a massaging pointing portion, and a massaging serially-protruding portion.

The main body comprises a top portion, a bottom portion, and a side portion.

The galvanic current applier is provided in the main body and configured for applying galvanic current from a first portion of skin of a user to a second portion of skin of the user, the galvanic current applier comprising a conductive surface disposed on the bottom portion of the main body.

The massager is provided next to the galvanic current applier in the main body and configured for contacting and applying mechanical vibration onto a third portion of skin of the user, the massager comprising a substantially flat surface disposed on the bottom portion of the main body.

The massaging pointing portion is provided on the side portion of the main body and configured so that the mechanical vibration is delivered from the massager.

The massaging serially-protruding portion is provided along the side portion of the main body and configured so that the mechanical vibration is delivered from the massager.

The galvanic current applier and the massager are installed fixedly in the main body and the conductive surface of the galvanic current applier and the substantially flat surface of the massager are connected to each other continuously.

The top portion and the side portion may be connected to each other so as to provide a curved surface with a contour adapted to a grabbing hand of a user.

The curved surface may be made of insulating material.

The galvanic current applier may further comprise a galvanic current generator disposed in the main body.

The galvanic current applier may further comprise a battery of a power supply for supplying electrical power to the galvanic current generator.

The power supply receives electricity from outside.

The galvanic current generator may generate a steady or pulsating galvanic current.

The galvanic current generator may comprise a controller for controlling the galvanic current steady or pulsating with adjustable frequency.

The conductive surface of the galvanic current applier may comprise a plurality of protruding line patterns.

The massager may further comprise a vibrator for generating the mechanical vibration using an electrical power.

The substantially flat surface, the massaging pointing portion, and the massaging serially-protruding portion may be made of insulating material.

The substantially flat surface may comprise a circular center and a plurality of triangular petals extending from and tilted away from the circular center.

The device may further comprise a detachable roller detachable from the side portion of the main body.

The detachable roller may be configured to be vibrated by the mechanical vibration generator.

The detachable roller may comprise a plurality of crests and valleys on a surface thereof.

The device may further comprise a handle receptacle and a handle.

The handle receptacle is provided on the top portion of the main body. And the handle is configured to be fixed to the handle receptacle. The handle is configured so that the user grabs and operates the device.

Another aspect of the invention provides a device, in which the conductive surface of the galvanic current applier and the substantially flat surface of the massager are incorporated with each other forming a hybrid surface portion.

Therefore, a same portion of the bottom portion of the main body works for the galvanic current applier and the massager.

The hybrid surface portion comprises a circular center and a plurality of triangular petals extending from and tilted away from the circular center. The hybrid surface portion has a shape of sun.

The advantages of the present invention are: (1) the device facilitates the use of the two separate functions in one place; and (2) the device provides a kind of synergy effect to the two different functions due to its housing in a body.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a device for skin care and massaging with a handle disassembled according to an embodiment of the invention;

FIG. 2 is a perspective view showing a device for skin care and massaging with a detachable roller according to another embodiment of the invention;

FIG. 2A is a bottom view of the device for skin care and massaging of FIG. 1;

FIG. 3 is a bottom view showing a device for skin care and massaging according to still another embodiment of the invention;

FIG. 4 is a bottom view showing a device for skin care and massaging according to still another embodiment of the invention;

FIG. 5 is bottom view showing a device for skin care and massaging according to still another embodiment of the invention;

FIG. 6 is a bottom view showing a device for skin care and massaging according to still another embodiment of the invention;

FIG. 7 is a bottom view showing a device for skin care and massaging according to still another embodiment of the invention;

FIG. 7A is a top view of the device of FIG. 7;

FIG. 8 is a block diagram showing a device for skin care and massaging according to still another embodiment of the invention; and

FIG. 9 is a side perspective view showing a device for skin care and massaging on a skin of user according to an embodiment of the invention.

### DETAILED DESCRIPTION EMBODIMENTS OF THE INVENTION

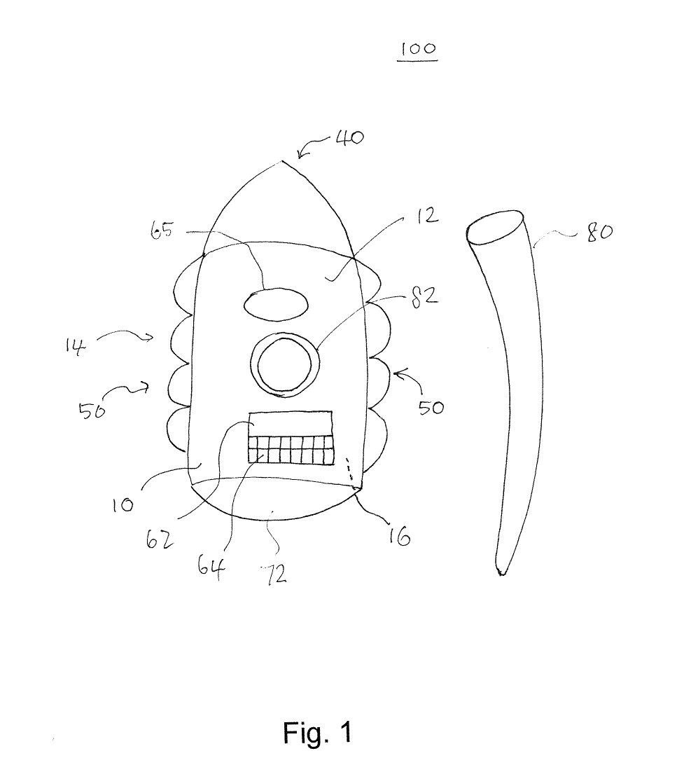

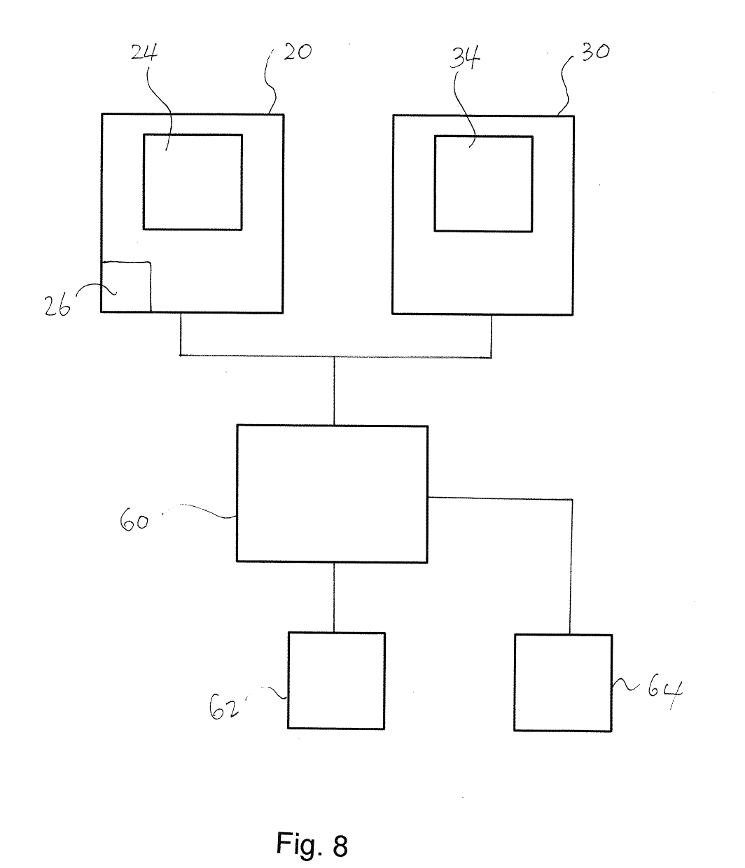

FIGS. 1-7 show devices for skin care and massaging according to embodiments of the present invention. FIG. 8 shows a block diagram for a device according to an embodiment of the invention.

An aspect of the invention provides a device for skin care and massaging 100.

The device 100 comprises a main body 10, a galvanic current applier 20, a massager 30, a massaging pointing portion 40, and a massaging serially-protruding portion 50.

The main body 10 comprises a top portion 12, a bottom portion 16, and a side portion 14 as shown in FIG. 1.

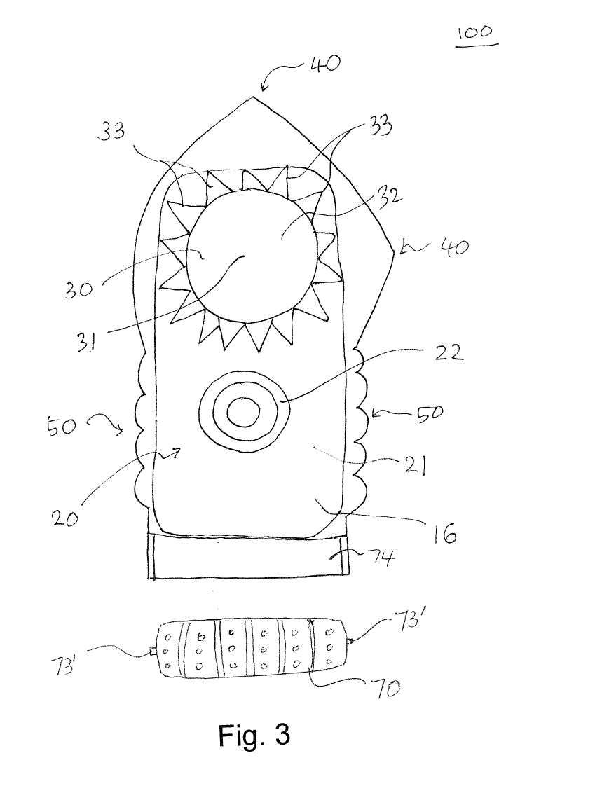

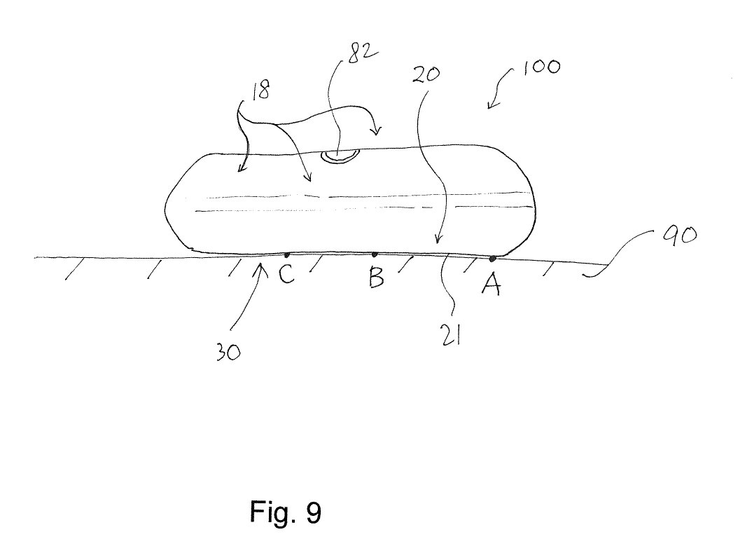

The galvanic current applier 20 is provided in the main body 10 and configured for applying galvanic current from a first portion A of skin 90 of a user to a second portion B of skin 90 of the user, the galvanic current applier 20 comprising a conductive surface 21 disposed on the bottom portion 16 of the main body 10 as shown in FIGS. 3 and 9.

The massager 30 is provided next to the galvanic current applier 20 in the main body 10 and configured for contacting and applying mechanical vibration onto a third portion C of skin of the user, the massager 30 comprising a substantially flat surface 32 disposed on the bottom portion 16 of the main body 10.

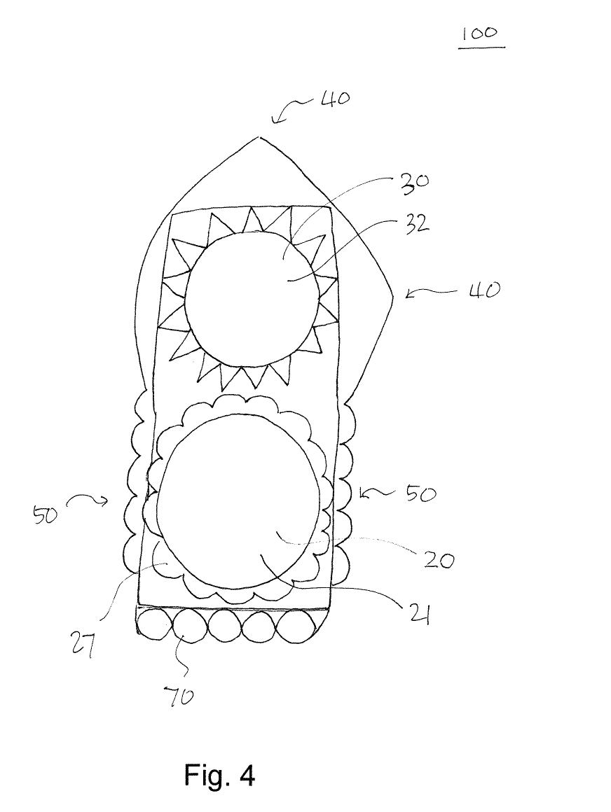

The massaging pointing portion 40 is provided on the side portion 14 of the main body 10 and configured so that the mechanical vibration is delivered from the massager 30. In certain embodiments, the device 100 may include more than one massaging pointing portion 40 as shown in FIGS. 3 and 4.

The massaging serially-protruding portion 50 is provided along the side portion 14 of the main body 10 and configured so that the mechanical vibration is delivered from the massager 30.

The galvanic current applier 20 and the massager 30 are installed fixedly in the main body 10 and the conductive surface 21 of the galvanic current applier 20 and the substantially flat surface 32 of the massager 30 are connected to each other continuously as illustrated.

The top portion 12 and the side portion 14 may be connected to each other so as to provide a curved surface 18 with a contour adapted to a grabbing hand of a user as shown in FIG. 9.

The curved surface 18 may be made of insulating material.

The galvanic current applier 20 may further comprise a galvanic current generator 24 disposed in the main body 10 as shown in FIG. 9.

The galvanic current applier 20 may further comprise a battery or a power supply 26 for supplying electrical power to the galvanic current generator 20.

The power supply 26 receives electricity from outside.

The galvanic current generator 24 may generate a steady or pulsating galvanic current.

The galvanic current generator 24 may comprise a controller 60 for controlling the galvanic current steady or pulsating with adjustable frequency.

The conductive surface 21 of the galvanic current applier 20 may comprise a plurality of protruding line patterns 22.

The massager 30 may further comprise a vibrator 34 for generating the mechanical vibration using an electrical power. Of course, the massager 30 may have its own controller, battery, power supply, or the controller 60 may control the operation of the massager 30 and the battery or the power supply 26 can be shared with the galvanic current generator 24.

The substantially flat surface 32, the massaging pointing portion 40, and the massaging serially-protruding portion b50 may be made of insulating material.

The substantially flat surface 32 may comprise a circular center 31 and a plurality of triangular petals 33 extending from and tilted away from the circular center 31.

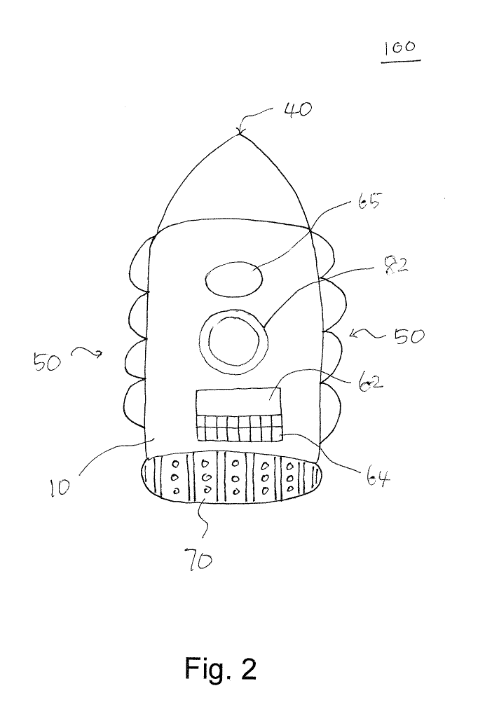

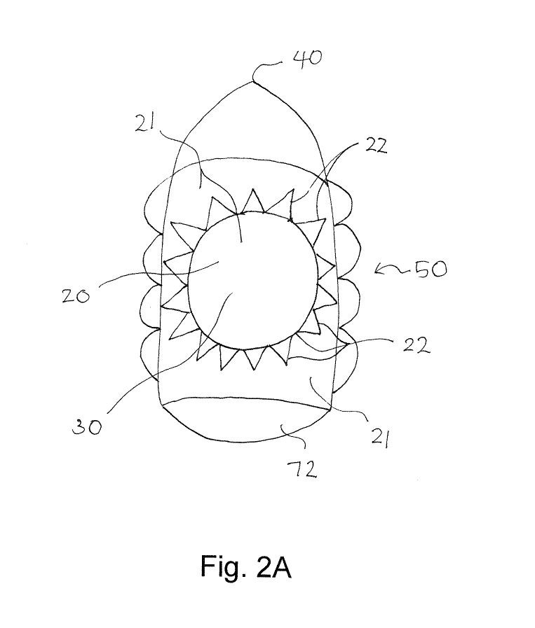

The device 100 may further comprise a detachable roller 70 detachable from the side portion 14 of the main body 10 as shown in FIG. 2. The detachable roller 70 can be sometimes noisy. Therefore, instead, at the same location, the device 100 may have a detachable smooth convex surface 72 as shown in FIG. 1. The attaching and detaching structure and operation is well known in the prior arts. It may have a clickable receptacle and latch.

The detachable roller 70 or the detachable smooth convex surface 72 may be configured to be vibrated and/or rolled by the mechanical vibration generator 34.

The detachable roller 70 may comprise a plurality of crests and valleys on a surface thereof.

The device 100 may further comprise a handle receptacle 82 and a handle 80.

The handle receptacle 82 is provided on the top portion 12 of the main body 10. And the handle 80 is configured to be fixed to the handle receptacle 82. The handle 80 is configured so that the user grabs and operates the device 100.

In certain embodiments, the controller 60 may further comprise a display 62 and a input device 64 as shown in FIGS. 1, 2, and 8. Additionally, the controller 60 may further comprise a power switch 65 as shown in FIGS. 1 and 2.

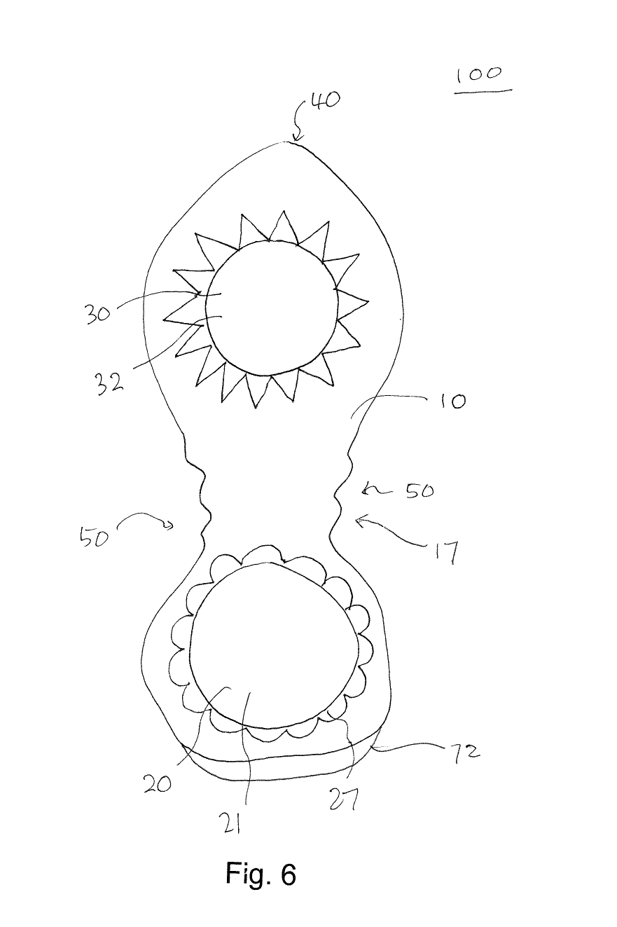

As shown in FIGS. 4 and 6, the conductive surface 21 may be smooth without any patterns.

Also, the conductive surface 21 may further comprise a plurality of petal-shaped patterns 27 for providing additional massaging surface or decoration as shown in FIGS. 4 and 6.

In FIG. 9, the galvanic current may flow from the first portion A to the second portion B of the skin 90 through the skin 90.

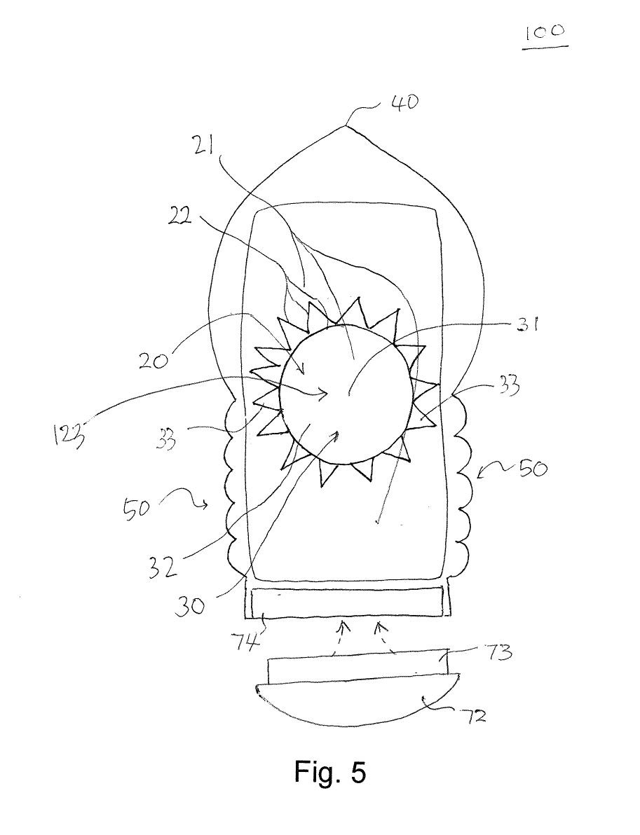

Another aspect of the invention provides a device 100, in which the conductive surface 21 of the galvanic current applier 20 and the substantially flat surface 32 of the massager 30 are incorporated with each other forming a hybrid surface portion 123, such that a same portion of the bottom portion 16 of the main body 10 works for the galvanic current applier 20 and the massager 30 as shown in FIG. 5.

The hybrid surface portion 123 comprises a circular center 31 and a plurality of triangular petals 33 extending from and tilted away from the circular center 31 as shown in FIG. 5. The hybrid surface portion 123 has a shape of sun.

In FIGS. 3 and 5, the detachable roller 70 and the detachable smooth convex surface may further comprise a fasteners 73,73′ which detachably attach them to corresponding receptacle 74.

Such fasteners 73, 73′ and receptacle 74 is of course not limiting.

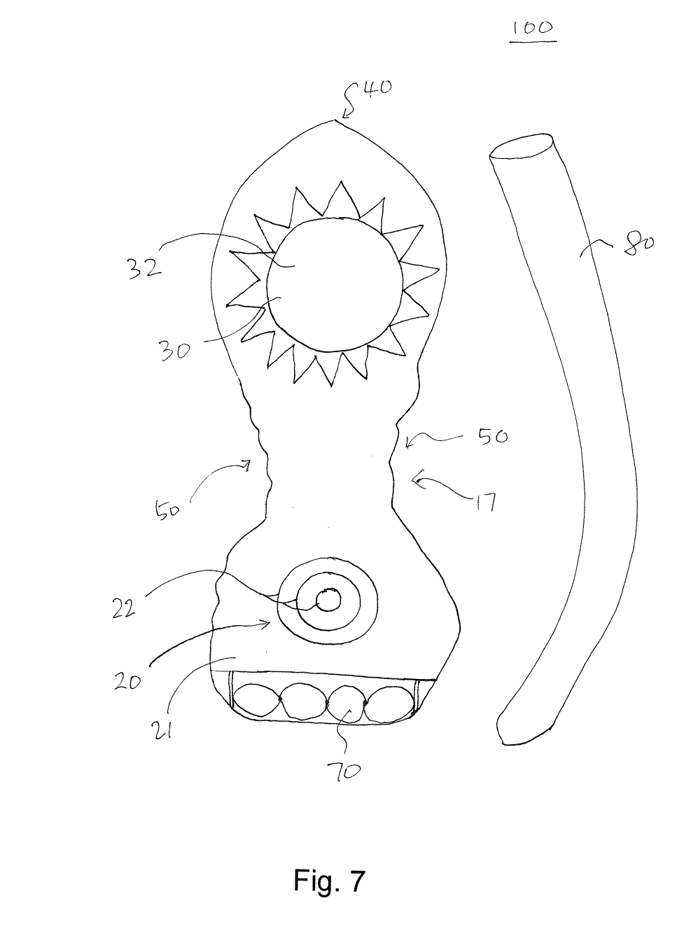

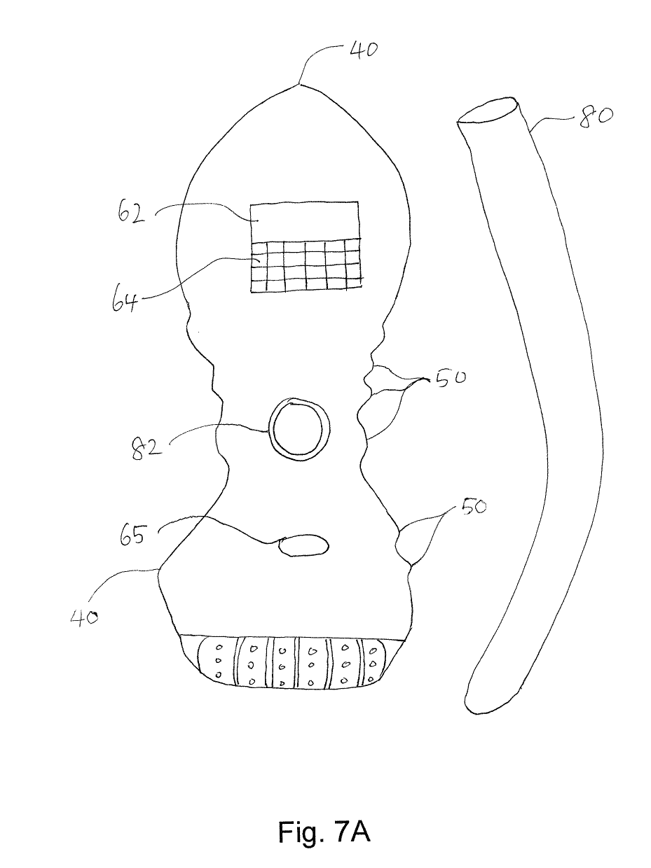

In certain embodiments as shown in FIGS. 6 and 7, the main body 10 may have a waist portion 17 between the galvanic current applier 20 and the massager 30. In such cases, the galvanic current applier 20 and the massager 30 must be provided separately.

FIG. 2A shows a bottom view of the device of FIG. 1. A single solar pattern works as galvanic current applier 20 and the massager 30 as in FIG. 5.

FIG. 7A shows a top view of the device of FIG. 7 with the detachable roller 70 instead of the smooth convex surface 72. The handle receptacle 82 may be disposed in the middle portion of the main body 10, such that the handle 80 can be attached to a kind of center of mass of the device 100.

In FIG. 7, the galvanic current applier 20 may have a plurality of protruding line patterns 22 (concentric circles in the illustrated embodiment) on the conductive surface 21, which covers about the half of the bottom portion of the main body 10. Of course, the plurality of protruding line patterns 22 can be replaced with the flower-shaped one in FIG. 6.

In certain embodiments especially illustrated in FIGS. 2A and 5, the conductive surface 21 and the substantially flat surface 32 are integrated into one, the hybrid surface portion 123 as described in the above. Such a hybrid surface portion 123 is conductive to the galvanic current through the skin 90 of the user. And at the same time, it works as a massaging surface. In the illustrated embodiments, the borders in the solar pattern may work for the plurality of protruding patterns. Still even without such a protruding patterns, since the skin surface is not perfectly smooth, the conductive surface 21 contacts the skin 90 here and there arbitrarily.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A device for skin care and massaging, the device comprising:
a main body comprising a top portion, a bottom portion, and a side portion;
a galvanic current applier provided in the main body and configured for applying galvanic current from a first portion of skin of a user to a second portion of skin of the user, the galvanic current applier comprising a conductive surface disposed on the bottom portion of the main body;
a massager provided next to the galvanic current applier in the main body and configured for contacting and applying mechanical vibration onto a third portion of skin of the user, the massager comprising a substantially flat surface disposed on the bottom portion of the main body;
a massaging pointing portion provided on the side portion of the main body and configured so that the mechanical vibration is delivered from the massager; and
a massaging serially-protruding portion provided along the side portion of the main body and configured so that the mechanical vibration is delivered from the massager,
wherein the galvanic current applier and the massager are installed fixedly in the main body and the conductive surface of the galvanic current applier and the substantially flat surface of the massager are connected to each other continuously.

2. The device of claim 1, wherein the top portion and the side portion are connected to each other so as to provide a curved surface with a contour adapted to a grabbing hand of a user.

3. The device of claim 2, wherein the curved surface is made of insulating material.

4. The device of claim 1, wherein the galvanic current applier further comprises a galvanic current generator disposed in the main body.

5. The device of claim 4, wherein the galvanic current applier further comprises a battery of a power supply for supplying electrical power to the galvanic current generator.

6. The device of claim 5, wherein the power supply receives electricity from outside.

7. The device of claim 4, wherein the galvanic current generator generates a steady or pulsating galvanic current.

8. The device of claim 7, wherein the galvanic current generator comprises a controller for controlling the galvanic current steady or pulsating with adjustable frequency.

9. The device of claim 1, wherein the conductive surface of the galvanic current applier comprises a plurality of protruding line patterns.

10. The device of claim 1, wherein the massager further comprises a vibrator for generating the mechanical vibration using an electrical power.

11. The device of claim 1, wherein the substantially flat surface, the massaging pointing portion, and the massaging serially-protruding portion are made of insulating material.

12. The device of claim 1, wherein the substantially flat surface comprises a circular center and a plurality of triangular petals extending from and tilted away from the circular center.

13. The device of claim 1, further comprising a detachable roller detachable from the side portion of the main body.

14. The device of claim 13, wherein the detachable roller is configured to be vibrated by the mechanical vibration generator.

15. The device of claim 14, wherein the detachable roller comprises a plurality of crests and valleys on a surface thereof.

16. The device of claim 1, further comprising:
a handle receptacle provided on the top portion of the main body; and
a handle configured to be fixed to the handle receptacle,
wherein the handle is configured so that the user grabs and operates the device.

17. The device of claim 1, wherein the conductive surface of the galvanic current applier and the substantially flat surface of the massager are incorporated with each other forming a hybrid surface portion, such that a same portion of the bottom portion of the main body works for the galvanic current applier and the massager.

18. The device of claim 17, wherein the hybrid surface portion comprises a circular center and a plurality of triangular petals extending from and tilted away from the circular center.

19. The device of claim 18, wherein the hybrid surface portion has a shape of sun.
